(19) United States
(12) Patent Application Publication
(10) Pub. No.: US 2002/0101379 A1
(43) Pub. Date: Aug. 1, 2002

(54) Attachable antenna for wireless modem

(76) Inventor: Mark Weinzierl, Frisco, TX (US)

Correspondence Address: Robert C. Klinger, Jackson Walker, L.L.P, Suite 600, 2435 North Central Expressway, Richardson, TX, 75080, US

(21) Appl. No.: 09/772,165

(22) Filed: Jan. 29, 2001

(51) Int. Cl. H01Q 1/24

(52) U.S. Cl. 343/702; 343/906

(57) ABSTRACT

The present invention is a low profile antenna for use with a PCMCIA card slot wireless modem (wireless modem) that provides convenient and effective performance. In one embodiment the invention is an antenna attachment for a PCMCIA card slot compatible wireless modem (wireless modem). The antenna attachment includes a base attachable to a wireless modem, and an antenna portion. The antenna portion is coupled to the base via a coupling. The antenna portion includes an antenna housing, and an antenna disposed within the antenna housing. The invention is also a method of coupling an antenna attachment to a PCMCIA card slot compatible wireless modem (wireless modem). The method includes the acts of disposing an antenna in a housing, and coupling the housing to a base.

### TECHNICAL FIELD OF THE INVENTION

The invention relates to wireless modem antennas, and more particularly, to wireless modem antennas configured for attachment to a [PCMCIA card slot] enabled wireless modem.

### STATEMENT OF A PROBLEM ADDRESSED BY THE INVENTION

As portable computing devices (such as personal digital assistants, (PDAs), and laptop computers, for example) proliferate, users of portable computing devices (PCDs) demand the ability to access intranets, and the Internet, wirelessly. To provide these users wireless access to the Internet and an Intranet, wireless modems capable of being inserted into a portable computers (PCMCIA) card slot have been designed and manufactured (PCMCIA card slot enabled wireless modems or, simply, “wireless modem.”). FIG. 1A (prior art) illustrates one such wireless modem 100.

The wireless modem 100 has a computer interface end 110, and an antenna 122 attached to an antenna end 120. Likewise, FIG. 1B (prior art) illustrates that the wireless modem 100, when viewed from the antenna end 120, has a thickness shown as T, and width illustrated as W.

Unfortunately, existing antenna implementations for wireless modems (wireless modem antennas) suffer from drawbacks. For example, wireless modems are generally incapable of providing a user feedback of antenna parameters or connections statistics without the user accessing some piece of software in the PCD. In addition, wireless modem antennas are often ineffective and rarely optimize a signal quality. Wireless modem antennas also frequently break from the wireless modem, thus rendering the wireless modem useless. Furthermore, wireless modem antennas frequently lack the ability to amplify or process a received signal, or to filter noise from that signal. Accordingly, it would be advantageous to provide a wireless modem antenna that is attachable to a wireless modem that overcomes the disadvantages associated with prior art wireless modem antennas.

### BRIEF OVERVIEW OF A SELECTED EMBODIMENT

The present invention provides technical advantages as a low profile antenna attachment for use with a PCMCIA card slot wireless modem (wireless modem) that provides convenient and effective performance. Preferably, the antenna attachment is embodied in a PDA sleeve device. Accordingly, the antenna attachment preferably fits snuggly into a wireless modem configured for use with a PCMCIA type II card slot. In one embodiment, the antenna attachment uses only a RF connector and a serial access connector to physically support the antenna attachment connection to the wireless modem. An antenna attachment generally comprises a base, and an antenna housing coupled to each other with a hinge capable of providing 180 degrees of travel. Furthermore, it is preferable that the antenna attachment provide functional operation in any hinge orientation.

In one embodiment the invention is an antenna attachment for a PCMCIA card slot compatible wireless modem (wireless modem). The antenna attachment includes a base attachable to a wireless modem, and an antenna portion. The antenna portion is coupled to the base via a coupling. The antenna protion includes an antenna housing, and an antenna disposed within the antenna housing.

In another embodiment, the invention is a method of coupling an antenna attachment to a PCMCIA card slot compatible wireless modem (wireless modem). The method includes the acts of disposing an antenna in a housing, and coupling the housing to a base.

In yet another embodiment, the antenna attachment provides visual status information regarding at least one antenna parameter for at least one performance statistic by using a display device, such as a LED or a LCD. The controlling power for the display device is preferably provided via a serial access connector. The logic used to interface the display device to the antenna is included within the base of the antenna attachment.

### BRIEF DESCRIPTION OF THE DRAWINGS

Various aspects of the invention, as well as at least one embodiment of the invention, are better understood by reference to the following EXEMPLARY EMBODIMENT OF A BEST MODE. To better understand the invention, the EXEMPLARY EMBODIMENT OF A BEST MODE should be read in conjunction with the drawings, in which:

FIG. 1A (prior art) illustrates a wireless modem;

FIG. 1B (prior art) shows an antenna end view of a wireless modem;

FIG. 2 illustrates an antenna attachment configured according the invention;

FIG. 3 illustrates one specific embodiment of an antenna attachment having a base coupled by a hinge to an antenna portion; and

FIG. 4 illustrates an antenna attachment coupled to the wireless modem.

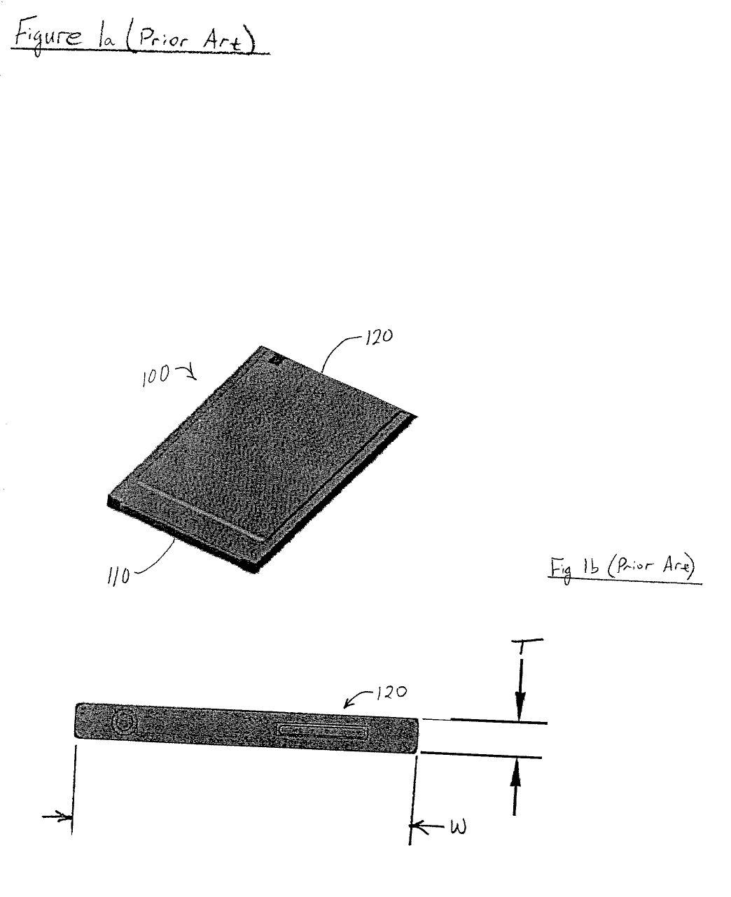

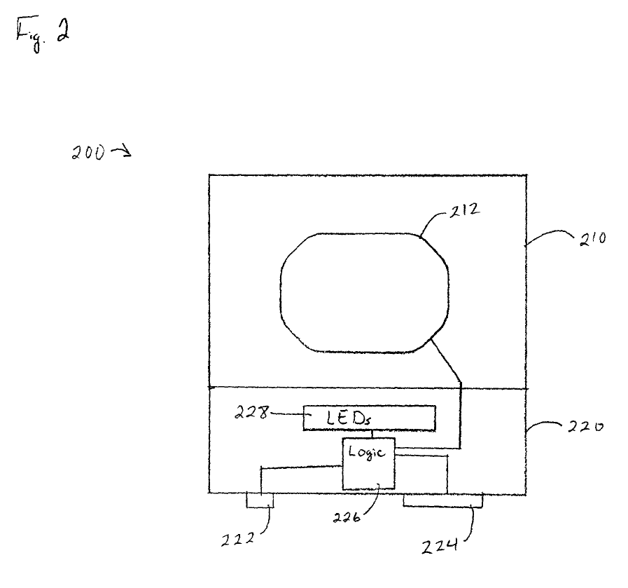

### AN EXEMPLARY EMBODIMENT OF A BEST MODE

The present invention is a low profile antenna for use with a PCMCIA card slot wireless modem (wireless modem) that provides convenient and effective performance, while fitting snuggly into a wireless modem configured for use with a PCMCIA type II card slot. In one embodiment, the invention is an antenna attachment for a PCMCIA card slot compatible wireless modem (wireless modem). The antenna attachment includes a base attachable to a wireless modem, and an antenna portion. The invention is also a method of coupling an antenna attachment to a PCMCIA card slot compatible wireless modem (wireless modem). The method includes the acts of disposing an antenna in a housing, and coupling the housing to a base.

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section.

FIG. 2 illustrates an antenna attachment 200 configured according the invention. The antenna attachment 200 includes a base 220 and an antenna portion 210. Both the base 220 and the antenna portion 210 have a width and a thickness that are approximately equal to the width and thickness of the wireless modem to which the antenna attachment 200 is to be mated. The antenna portion 210 is coupled to the base 220 mechanically via a coupling, such as a hinge. The hinge should be capable of adjustment to different angles (from 0 to 180 degrees). In addition, the coupling should be crafted such that when pressure is released from the hinge the position of the hinge is rigidly fixed to support the antenna portion 210 at an angle relative to the base 220.

The antenna portion 210 functions as an antenna housing for an antenna 212 that is electrically coupled to a logic 226 in the base 220. The antenna 212 may be an omnidirectional antenna, a unidirectional antenna, or an antenna of adjustable physical and electrical parameters. By adjusting the angle of the antenna portion 210 relative to the base 220, a user may modify the antenna orientation to achieve an optimal receive signal strength. This optimal receive signal strength may be displayed for a user as discussed below. Preferably, the It antenna 212 is capable of frequency coverage of about 824 Mhz to about 895 Mhz. Often, the preferable gain of the antenna should be better than negative 1 dBi, and the return loss of the antenna in a frequency band selected by the user should be better than 10 dB. Note that the antenna polarization is preferably vertical when the unit is orientated vertically. Furthermore, the antenna preferably exhibits no increase in thermal noise, digital interference, or any other type of interference across frequency bands which may be needed by a user.

The base 220 preferably provides two electrical connectors for mating the antenna attachment to the wireless modem. Preferably, a radio frequency (RP) connector 222 is used along with a serial access connector 224, such as a 15 pin connector, to provide an interface for antenna signals and communication between the logic 226 of the antenna attachment and any processing capabilities of a portable computer or other PCD. While the RF connector 222 and the serial access connector 224 are illustrated in FIG. 2, it should be understood that any connector or connectors that offer a reliable connection to a wireless modem and meet the spacial needs of the antenna attachment and wireless modem may be used.

The electrical connectors provide input and output capability to a wireless modem through the logic 226. The logic 226 may be implemented as an available logic chip (such as the 74HC595), a digital signal processor (DSP), or a general purpose processor (such as a Pentium processor), for example. Accordingly, the logic 226 is preferably capable of indicating various antenna parameters and performance statistics via a display device 228, which may be implemented as a liquid crystal display (LCD) or via a plurality of light emitting diodes (LED). Possible antenna parameters that may be covered include a power status (such as on, sleeping, or standby), a transmission activity status, or a connection status. A performance statistic capable of being monitored includes an optimal antenna physical configuration, or other information capable of enabling a user to more effectively connect to a wireless network, for example. In the event that a LED is used, control for the LED may be accomplished by processing information in a wireless modem and then sending the information through the serial access connector 222. When a plurality of LEDs are used, the LEDs may be turned on or off independently of each other and a specific LED of a predefined color may indicate a particular antenna parameter or performance statistic. The colors and shapes of the LEDs may be selected to allow a user to easily differentiate between the LEDs, and to provide an aesthetically pleasing enhancement to the antenna attachment housing.

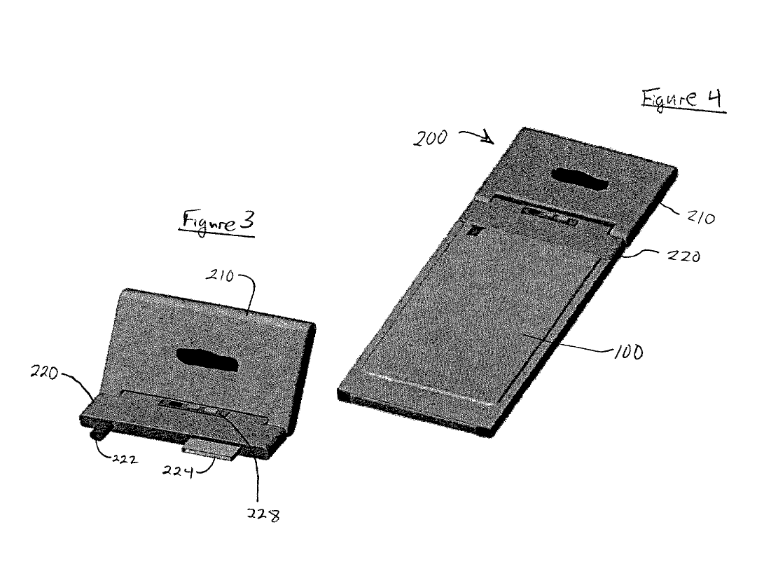

FIG. 3 illustrates one specific embodiment of an antenna attachment having a base 220 coupled by a hinge (not shown) to an antenna portion 210. The base 220 includes a plurality of diodes 228 for illustrating antenna parameters and performance statistics. Furthermore, a RF connector 222 and a serial access connector 224 are provided for interfacing the antenna attachment to a wireless modem. Note that the antenna portion 210 is bent at an angle “theta (θ)” relative to the base 220.

Similarly, FIG. 4 illustrates the antenna attachment 200 coupled to the wireless modem 100. From FIG. 4 one may see that the antenna attachment 200 and the wireless modem 100 provide the appearance of a unified piece of hardware when connected (since they have approximately the same width and thickness). In FIG. 4, one should note that the antenna portion 210 has been adjusted via the hinge so that the angle theta relative to the base 220 is now 0 degrees.

Though the invention has been described with respect to a specific exemplary embodiment, many variations and modifications will become apparent to those skilled in the art upon reading the present application. It is therefore the intention that the following claims be interpreted as broadly as possible in view of the prior art to include all such variations and modifications.

What is claimed is:

1. An antenna attachment for a PCMCIA card slot compatible wireless modem (wireless modem) comprising:
a base attachable to the wireless modem; and
an antenna portion coupled to the base via a coupling, the antenna portion comprising an antenna housing and an antenna disposed within the antenna housing.

2. The antenna attachment of claim 1 wherein the base comprises at least one port for electrically coupling the base to the wireless modem.

3. The antenna attachment of claim 2 wherein the port is a parallel-type radio frequency (RF) connector.

4. The antenna attachment of claim 2 wherein the port is a serial access connector.

5. The antenna attachment of claim 2 further comprising a logic circuit maintained within the base for detecting antenna parameters, the logic circuit being coupled to the port.

6. The antenna attachment of claim 5 wherein the logic circuit monitors at least a power status.

7. The antenna attachment of claim 5 wherein the logic circuit monitors at least a transmit activity.

8. The antenna attachment of claim 5 wherein the logic circuit monitors at least a connection status.

9. The antenna attachment of claim 5 further comprising at least one light emitting diode (LED) coupled to the logic.

10. The antenna attachment of claim 5 further comprising a liquid crystal display (LCD) coupled to the logic.

11. The antenna attachment of claim 1 wherein the coupling is a hinge.

12. The antenna attachment of claim 11 wherein the hinge is capable of being rigidly fixed to support the antenna portion at an angle relative to the base.

13. The antenna attachment of claim 1 wherein the antenna housing has approximately the same width and thickness as the wireless modem.

14. The antenna attachment of claim 1 wherein the base has approximately the same width and thickness as the wireless modem.

15. A method of coupling an antenna attachment to a PCMCIA card slot compatible wireless modem (wireless modem), comprising:
disposing an antenna in an antenna housing; and
coupling the antenna housing to a base.

16. The method of claim 15 wherein the antenna housing has approximately the same width and thickness as the wireless modem.

17. The method of claim 15 further comprising the act of attaching the antenna attachment to the wireless modem.

18. The method of claim 15 further comprising the act of detecting at least one antenna parameter.

19. The method of claim 15 further comprising the act of displaying information regarding at least one antenna parameter.

20. The method of claim 18 further comprising the act of displaying at least one antenna parameter.
